(19) United States
(12) Patent Application Publication
(10) Pub. No.: US 2009/0287034 A1
(43) Pub. Date: Nov. 19, 2009

(54) Water-Soluble Package With Functional Depot As Well As Manufacture And Utilization

(75) Inventor: Andreas Siggelkow, Tutzing (DE)

Correspondence Address: BACHMAN & LAPOINTE, P.C., 900 CHAPEL STREET, SUITE 1201, NEW HAVEN, CT, 06510, US

(73) Assignee: Andreas Siggelkow, Tutzing (DE)

(21) Appl. No.: 12/469,784

(22) Filed: May 21, 2009

Related U.S. Application Data
(63) Continuation-in-part of application No. PCT/EP2008/007292, filed on Sep. 5, 2008.

(30) Foreign Application Priority Data
Sep. 6, 2007 (DE) 10 2007 042 450.9
May 23, 2008 (DE) 10 2008 024 832.0

(51) Int. Cl. B09B 3/00; C11D 17/00

(52) U.S. Cl. 588/249.5; 510/296

(57) ABSTRACT

A water-soluble package, having a water-soluble foil defining a first compartment and at least one second compartment separate from the first compartment, wherein the at least one second compartment contains a functional depot.

### CROSS REFERENCE TO RELATED APPLICATION

This application is a continuation-in-part of PCT application number PCT/EP2008/007292 filed Sep. 5, 2008, which designated the United States.

### FIELD OF THE INVENTION

The invention relates to a package, consisting of a water-soluble foil with integrated functional depot, which is dimensioned in a way to hold a pre-defined amount of laundry and features at least one second compartment to contain the amount of washing agent required for the intended washing process as well as manufacture and utilization of this package with functional depot.

### BACKGROUND OF THE INVENTION

Modern washing machines—especially those in the upper and top price segment—are able to determine the amount of laundry filled into the machine, and with the built-in electronics, programmed with the water hardness at the respective geographic location, are able to calculate the amount of washing agent needed, considering the selected washing program. However, washing machines which such options are found rather seldom in everyday life, which leads to the tendency to use more washing agent than actually needed, in order to gain especially good washing results, which leads to increased costs while resulting in a higher strain for sewage plants and increased strain for the environment. Based on European standards, the potable water in Germany is classified according to three water hardness categories: soft, medium and hard. Since modern washing agents, based on tensides, are less sensitive to the water hardness, caused by the salts of earth alkali metals, and are already equipped with (phosphate-free) water softeners, the amount of washing agent, required for class 1 water hardness, (soft) is usually sufficient. Only if washing temperatures above 60° C. are required, the additional use of a phosphate-free water softener is recommended. In most cases, a special “pre-washing” of the laundry is abdicable—if pre-washing takes place, it is carried out with the “hot wash” in the temperature range of 60° C. or above—a “pre washing” is carried out with cold water and is used to help removing stains caused by proteins or blood. Laundry can be categorized into “wool laundry”, “fine laundry”, “white laundry”, “colored laundry” and “laundry for high washing temperatures”. “Fine laundry” and “colored laundry” are usually washed with water temperatures of 30° C. or 40° C., while “laundry for hot wash” is washed at 90° C.—however, experience shows that such laundry can also be washed with good results at 60° C., which considerably saves energy. In general, the use of a mild detergent for “delicates” and “colored laundry” and a premium detergent for “hot wash” is usually sufficient. Dirty clothes made of wool usually represent only a fraction of the laundry of an average household and are usually washed with special detergents. Mostly, sensitive clothes made of wool are hand-washed.

Laundry bags of different designs, that are washed together with the laundry in a washing process, are well known. In order to allow the washing liquid to intrude into the laundry easily, netted bags, made of cord are used. Their disadvantage is that the hard knots of the mesh may damage sensitive fabrics, and on the other hand these knots are stressed mechanically by the washing process, which considerably limits the lifetime of those netlike materials. This has led to the search for laundry bags made of weaved fabrics. Such fabrics needed to be highly durable while not becoming too heavy after having absorbed water. At the same time, the material should not be too porous, in order to effectively eliminate any accumulation and consecutive reproduction of microorganisms within the fabric. Since such laundry bags require rather high production costs, they needed to be re-usable and needed to be designed in a way to withstand the temperatures of tumble dryers, since melting plastic materials would have destroyed the laundry irreparably. As a conclusion, it can be stated that there are several conflicting goals already known from the prior art, influencing the development of a successful problem solution to get a container for collecting and sorting laundry of different types, which is easy to handle, while allowing production at low costs.

DD 001161 U describes a laundry bag made of a cotton or polyamide fabric that features a hollow hem with a cord used to seal the bag. Although this “spin-dryer washing bag” does not impose any strain on the laundry it contains, it needs to be opened manually prior to the washing procedure in order to empty its contents into the washing machine. It also needs to be washed together with the laundry. In case the bag is washed while containing the laundry, excessive imbalance during the drying and spinning process might result.

DE 17 44 019 U describes a laundry bag made of a Polyester fabric, which avoids the disadvantage of cotton fabrics, but does not overcome the disadvantage of the problem solution already known from DD 001161 U.

DE 94 21 043 U describes a laundry bag which opens itself inside the washing machine, consisting of an especially folded fabric, which opens up during the first phases of the washing process. This laundry bag is re-usable—but it needs to be washed together with the laundry and also needs to be dried and folded after each washing cycle, before it can be used again. At least, this problem solution offers the advantage that no unauthorized persons can get into contact with dirty or even infectiously contaminated laundry while opening the laundry bag.

DE 89 03 043 U therefore describes a laundry bag which automatically opens itself inside the washing machine, which is made of a material with waterproof coating on the inside in order to allow safe transport of infectiously contaminated laundry as it is found especially in clinical applications whereby it is ensured that clinical personnel do not get in direct contact with the laundry during transport or while filling the washing machine.

DE 90 16 622 U proposes a folded “dosing bag” for a washing agent in the form of a powder, which consists of a water permeable fabric, which can hold a defined amount of washing agent and opens itself at the beginning of the washing process. This “dosing bag” is also re-usable.

The patent literature knows a number of water-soluble packages which are used for example to hold hazardous substances, such as pesticides, herbicides and the like and are intended to provide single-service package for agricultural use. They are simply inserted into a specified amount of water in order to gain the correct dosage for spraying. Such packages are described e.g. in WO-A 97/27743 and EP-B 0 347 221. They usually consist of a foil made of polyvinyl alcohol. The water solubility of this material can be influenced and controlled by respective additives and special manufacturing processes, such as mono-axial or bi-axial stretching during the extrusion process.

EP-A 0 700 989 describes a packaged cleaning agent for dishwashers wrapped into a foil made of polyvinyl alcohol which wraps around the cleaning agent until the beginning of the main cleaning process of the dishwasher.

GB-A 2,305,931 describes a water-soluble detergent container, consisting of two halves, which are connected to each other and contain a washing powder or dish washing detergent. This specification does not contain any information as to the material used.

FR-A 2 601 930 describes a water-soluble bag containing some type of substance, preferably a pharmaceutical substance. GB-A 2,090,603 refers to a water-soluble foil made of a combination of partly hydrolyzed polyvinyl acetate and polyacrylic acid.

EP-B 0 556 781 describes a water-soluble thermoplastic foil material, consisting of a copolymer made of N-vinyl acetamide and another suitable vinyl monomer, such as vinyl acetate or vinyl butyrate.

DE-A 101 40 597 reveals the use of cross-linked polyvinyl alcohols derived for example by processing polyvinyl alcohol with dimethyl tartrate, for the production of synthetic granules used for the production of water soluble foils. By skilful selection of the ester components, the water solubility of the foils can be variegated. The specification also includes synthetic granules which allow the production of foils, which only swell up and soften in water without dissolving completely.

The prior art includes several suggestions as to the requirements suitable for a water soluble package for washing agents, dish detergents or compositions for agrochemical use, and how the solubility of such a packages can be variegated in a time-controlled manner—additionally there are suggestions as to the characteristics of laundry bags designed for the temporary storage of laundry, which allow pre-selected feeding of the washing machine, preferably without anyone needing to open such a bag prior to filling its contents into the washing machine. In this connection, however, it is disadvantageous that the package itself remains in the washing machine, which means added weight and reduces the “usable net weight” of the laundry to be washed, and which requires subsequent drying and manual preparing of the packages prior to any repeated use. In case the package contained contaminated materials, there is also the need for disinfection.

### SUMMARY OF THE INVENTION

Therefore the object of the invention was to provide a water-soluble package, consisting of one first and at least one second compartment, which are strictly separated from each other. The first compartment serves to hold laundry, the second compartment serves to contain the required amount of washing agents needed for the intended washing procedure, additional compartments, if so, may contain e.g. disinfectants, in case the soluble package is to be used for infectiously contaminated laundry from hospitals, or they may also be used for additional washing additives, such as phosphate-free water softeners, bleaching agents, stain removers or similar products, where the separation of such additives is especially important if it is desired or even required to prevent any contact between these substances prior to the washing process. Such additives should preferably be available in water-free form, such as powder, granulate or in compressed form. However, it would also be an advantage, if washing agents and additives can also be used in the form of fluids, pastes or gels. The size of the first, second and where applicable any additional compartment needs to be adjusted to the defined volumes. For example, the first compartment needs to hold a specified amount of dirty or contaminated laundry, such as 1-2 kg, 3 kg, 4-5 kg or 6 kg for household use, and the size of the second and where applicable any additional compartment needs to be adjusted accordingly, in order to hold the amount of washing agent or additives required for the intended washing process. For commercial use, the size of the first compartment needs to be bigger in order to hold for example 7.5 kg, 10 kg, 15 kg or 20 kg of dirty laundry. The second compartment needs to be adjusted to the amount of laundry in the first compartment. Besides that it is to be made certain that the walls of such a water-soluble package need to allow easy handling without the danger of tearing prior to the washing process. However, when inserted into the washing liquid, it is necessary for the laundry to absorb the liquid as soon as possible, wherefore the water-soluble package shall open within the liquid as fast as possible, which might be supported either by means of perforations or rated break points. The foils selected to design a water-soluble package need to dissolve completely and residuelessly during the washing process, and any residues left in the water need to be biodegradable without causing any excessive strain for sewage plants.

Since foils with different characteristics as to their ability to dissolve in water are well-known—some of them dissolve only at temperatures above 50° C.—it was another object of this invention to provide a package for hot wash, holding washing agents for two different washing programs. Principally, this type of laundry is first pre-washed in cold water, in order to dissolve stains caused by blood or substances with a high protein content, the main wash cycle then is carried out at elevated temperatures, preferably above 60° C. The washing agent for pre-washing therefore should be inserted into the second compartment, along with the washing agent for the main wash cycle—in an additional water-soluble package, which then can be seen as a further compartment, spatially separated from the first compartment, which only may dissolve in water at a temperature above 50° C. The dissolving at this also shall occur within a few minutes.

For the field of clinical laundry it was another object of this invention, to provide a package, which allows the safe storage of especially stained or infectiously contaminated laundry, which means a package according to the required security procedures, for laundry, stained with substances, such as blood, protein containing substances, wound secretions, and sputum, as well as bacterially infected laundry, since laundry like this needs to be disinfected and washed without getting into contact with employees during the process of storage, transportation or filling the washing machine.

Work clothes used in smelly areas, as they are common in agriculture, poultry breeding, chemical industries, e.g. when handling mercaptanes or synthetic or other odorous substances, pharmaceutical industries and the like can be a real bother if they are stored temporarily in a package according to this invention until the package is filled completely. Therefore here a problem solution is required, which allows repeated opening and closing of the package according to the invention, until it is filled optimally and ready for washing, to avoid strong odor or at least noticeably reduce it.

The foil material to be used should preferably be of thermoplastic nature and allow easy hot-sealing or gluing with a suitable adhesive which will also dissolve in the washing liquid without leaving residues. The material should also be easy to supply, in order to allow marketing of such a package at competitive prices. It should be possible to distribute such laundry bags in the form of shipping cartons containing multiple units. Finally it was the object of the invention, to provide a suitable foil-material for a water-soluble package in a way that the water-soluble package, already containing further product in it's original state in the second compartment for later use, can be folded or convolved anywise spatially minimized in a highly compact form, for cost effective storage and transport of the package. Of course, the individual layers of the foils of such a water-soluble package must remain intact during the storage at the point of sale or at the consumer's home, without sticking to each other or becoming brittle.

Packages as described above are ideal as “collectors” for laundry and suitable for private households, as well as small businesses, such as restaurants, bars, bistros, medical practices etc., since such package can be made available with a defined volume—such as 1-2 kg, 3, kg, 4-5 kg, 6 kg—matching the optimum filling volume of a typical household washing machine or matching the “energy saving” programs of such machines, which is especially suitable for a “single household”.

For commercial applications, the desired package can be designed more voluminous, e.g. with a maximal capacity such as 7.5 kg, 10 kg, 15 kg or 20 kg, to match the larger capacity of commercial washing machines—made from a sturdier while still easily water-soluble wrapping material with an adequate larger supply of washing agent. By using multiple packages of this type side by side, it is possible to pre-sort the laundry in order to simplify the later washing process with the required washing programs.

Since the provided water-soluble package is to be used for separation and sorting of laundry in private households, it was a further object of the invention to re-enforce the edges of the water-soluble package alongside the upper end of the first storage compartment in a way to allow hanging the package into a suitable stand without being damaged, overstretched or torn by the weight of the accumulating laundry. As several versions of the water-soluble package shall be provided, the foil must be printable in a well-known and common way to indicate the intended use to the consumer, such as “wool”, “delicates”, “linen”, “colored laundry”, “hot wash” etc. and to indicate the maximum capacity of the respective unit. The business company, distributing such a package, also needs to be able to apply the legally required product information, as well as sales promotional statements. Naturally, any imprints on the foil must not stain the laundry during the washing process.

In order to reduce the overall weight of the package, the walls of the first compartment are repeatedly stamped out with a suitable cutter, to create what is in the broadest sense a net-like structure. Needless to say that applying such openings can also be achieved in any other way known by any person skilled in the art. The space between all elements of this net-like structure—meaning the size of the openings—must be selected in the way to be sized smaller than the smallest piece of laundry, for which the package is intended, such as a crumbled up handkerchief or a sock for children. If the invented package shall be used, for example, for the laundry of a hotel, these openings can have a larger dimension, provided the required stability and tear-resistance of the package according to the invention are not compromised. The residues of the foil when the net-like structure is punched out can be recycled for production of new foils.

The punching is done in a way that despite lower weight, a widely tear proof package is provided. It is particularly favorable, if the foil is not manufactured in a uniform thickness but with structures of increased thickness in longitudinal direction in the sense of “bearing and supporting elements”. Naturally, the number of this structure or these structural elements is dependent on the weight of the laundry the package is intended to hold.

The subsequent punching of the net-like structures described above, needs to be carried out in a way that the function of the reinforcing structures of the package according to the invention is not interfered with by this processing. According to the German Patent Application DE 10 2007 042 450.9 the first compartment needs to be designed in a way to hold 1-2 kg, 3 kg, 3-5 kg or 6 kg of dirty (or if so also contaminated) laundry for the domestic range or 7.5 kg, 10 kg, 15 kg or 20 kg of dirty (or if so also contaminated) laundry for commercial sector.

The maximum size of the punched-out holes and the remaining “ligaments” in-between and finally the nature of this net-like structure can be easily determined by tear-resistance tests. The resulting tear-resistance should be at least 50% higher than the respective maximum total weight of a fully filled package would require.

The punched-out holes can be of any shape, such as round, oval, rectangular, square, trapezoid, rhombical or in an irregular form. It is solely of importance that punching or positioning of holes saves at least 50%, preferred at least 70% and especially preferred at least 80% the previous weight of the plastic material of the package according to the invention, thereby reducing the amount of foil, to be dissolved in the washing liquid.

Instead of using a foil with structures of increased thickness in longitudinal direction in the sense of “bearing and supporting elements”, it is also possible to add such “bearing and supporting elements” subsequently on an already processed foil by applying strips of foils made of water soluble material. This can be done by either ultrasonic sealing, or by moistening the strips to cause a sticking effect, or by bonding it with a suitable bonding agent. In principle it is also possible to apply strips of foil to the bag to form “bearing and supporting elements”, prior to punching the required holes. These “bearing and supporting elements” only serve to guarantee the stability and bearing capacity of the package according to the invention, after the weight of the foil was reduced from punching holes that followed, in order to reduce its weight to the extend possible. These “bearing and supporting elements” need to run from the lower seal of the package all the way to the doubled-up hem at its top opening. To achieve its function, it is insubstantial, whether the supportive strips are mainly applied horizontally between these two points or run diagonally or in form of any possible curve.

Another embodiment of the package uses a section of a tubular foil of any suitable geometry, which is then filled with the washing agent required for the watching process, as well as any other required additives, which thereafter is sealed in order to form the “second compartment”, and then is applied onto the package in a way to provide a “bearing and supporting element” as aforesaid. The required amount of washing agent and other additives, if required, is derived from the intended package-size and accordingly from the maximal storage capacity of the first compartment holding the laundry, whereby then the dimensions of the required tubular foil as to its length and diameter can be achieved simply. Preferably, the required section of the tubular foil is approximately of the same length as the package measured from its lower seal to its folded upper hem. As already described hereinbefore, it is insubstantial, whether the sections of foil filled with washing substances are applied mainly vertically between upper and lower end of the package according to the invention, or diagonally or at any curved line possible.

In a further embodiment, a tubular foil is manufactured in the known manner and, when positioned plain, furnished with the aforesaid punched-out holes. The resulting net-like structure is then cut in the desired sections and finished to the package according to the invention. At this it is advantageous to punch-out the holes intermittently, in order to be able to cut the resulting tubular foil in these areas, which remain unpunched to close the walls of these sections permanently, e.g. by hot-sealing or ultrasonic sealing, to provide the desired water-soluble package with functional depot.

At this point, the prime idea behind the invention needs to be emphasized: It is essential to provide a package, able to hold a specified amount of laundry, which then is reserving an appropriate amount of washing agents, additives and other substances needed. In case the package is made of a material with punched-out openings, the required amount of washing agents, additives and other substances if needed, will need to be filled in a suitable separate package, which also consists of water-soluble material and which is tightly sealed to form the second compartment which is joint to the first compartment holding the laundry. It remains considerably important that these inserted amounts of substances cannot be removed from the water-soluble package with functional depot without visibly damaging or destroying it.

In another embodiment, from a water-soluble plastic material as described in detail in DE 10 2007 042 450.9, an endless filament or an endless strip-like tape is manufactured, which is subsequently woven by a well-established weaving method to a net-like plain or tube-like fabric, from which water-soluble package with functional depot, according to the invention, is produced by the aforesaid manner. When indicated, the knot-like sections of this fabric can be subjected to a short thermal treatment, in order to strengthen it and to get it inherently stable. Also in this way a water-soluble package with functional depot can be produced, with a second compartment to hold the required amount of washing agents, additives and other substances, if needed, contained in a suitable separate package, which is also made of water-soluble material. This second compartment is sealed as described above. For this solution as well, the tensile strength of the filament or tape, as well as the tensile strength of the resulting fabric will need to be tested in a simple and suitable way.

Besides the lower net weight of the water-soluble package according to the invention with functional depot, it is particularly advantageous that the provided laundry will be soaked with water very fast, which considerably increases its weight and causes the surrounding packaging material to tear open much faster in order to release the laundry.

The material used for the package according to the invention preferably dissolves completely while being already in contact with cold water. The washing agents, additives and other substances stored in the second compartment may also be packed in separate bags made of different types of foil, so that the washing agent, intended for pre-washing or a disinfectant are packed in a foil, already dissolving in cold water, since pre-washing is done with cold water, while the washing agent intended for the main wash cycle is packed with a foil completely dissolving in water only at temperature levels above 40° C. In this way, two different washing procedures can be successfully performed consecutively.

That object is attained by selecting synthetic granules, available in the trade, a processable material for forming thermoplastic foils is selected, which can be processed into tube-like foils by means of standard production technologies. In order to ameliorate its mechanic characteristics, this material may be stretched mono-axially or bi-axially during the extrusion process. The synthetic granules may be selected from a mixture of polyvinyl acetate and polyacrylic acid or polyvinyl alcohol or partially hydrolyzed polyvinyl alcohol or a copolymer made of N-vinyl acetamide and vinyl acetate or a copolymer of N-vinyl acetamide and vinyl butyrate or methyl hydroxypropyl cellulose or a polycondensate from polyvinyl alcohol and dimethyl tartrate or a polycondensate from polyvinyl alcohol, citric acid and phthalic acid anhydride or similar granulates for the production of water-soluble foils, which are freely available in the trade. In general it is also possible to use so-called “biopolymers” derived from renewable raw materials by chemical processes. Such “biopolymers” for the production of water-soluble foils, as well as all other plastics stated—polymers, copolymers, polycondensates and their mixtures—are well known to the persons skilled in the art. By the reaction of polyvinyl alcohol with a mixture of maleic acid anhydride and phthalic acid anhydride in a polycondensation, it is possible to produce synthetic granules suitable for foils which only soften at increased water temperatures or are only partially soluble. By using such foils, it is possible to produce small bags containing washing agents in the form of fluids, pastes or gels which are inserted into a the second compartment of the package according to the invention, spatially separated from the first compartment. These small bags will only dissolve in the main wash cycle, when getting in contact with the hot washing liquid, then releasing their content. The release of this washing agent will be promoted by the rotating movement of the drum of the washing machine, as well as the motion of the laundry itself. It might be necessary to remove residues of such small bags and dispose of them manually.

Matching the requirements of small households, e.g. for singles or for “small washing” only in limited quantities, or for the use of the energy saving programs of washing machines, the packages according to the invention are manufactured in a way that the first compartment can hold only 1-2 kg or 3 kg of laundry. For general household use, the package according to the invention must be available with a capacity of 4-5 or 6 kg of laundry, which matches the maximum load capacity of the commercially available washing machines. The amount of washing agent and eventually needed additives in the second or any additional compartment shall be dimensioned in a way to be sufficient for the maximum laundry capacity of the package without causing any over-dosage. The amount of washing agent shall be adjusted to the new water hardness class 1 (soft) according to EU classification. Other proportions and dosages shall not be excluded—if manufacture and distribution of the package according to the invention primarily occurs in areas with hard or extra hard water, it is possible to adjust the dosage of the washing agent accordingly.

For industrial applications and commercial laundries, where dirty working clothes, tablecloths from restaurants etc. will be pre-sorted and washed later on, embodiments of packages according to the invention are made available with a capacity of more than 6 kg up to 20 kg. For this, embodiments of packages according to the invention are chosen that can hold 7.5 kg, 10 kg, 15 kg or 20 kg of laundry. The amount of washing agents and additives, contained in the spatially separated second compartment and if necessary additional compartments shall be adjusted accordingly. Naturally, it is also possible to provide packages according to the invention with capacities of more than 20 kg e.g. for commercial use—since the limiting factor for maximum capacity of the package according to the invention is only the capacity of the commercial washing machine—however, for safety at work, such heavy units requiring the use of special handling equipment, which actually suggests the use of smaller units with a maximum weight of 10 kg or 20 kg, which allow easy handling for the operational staff.

In order to increase the braking strength of the foil—especially when it comes to the production of packages according to the invention with increased capacity and a maximum load between 10 kg and 20 kg—it is favorable not only to use foils with higher strength, but to equip the foil with axial profiles of higher material thickness. For the production of water-soluble package according to the invention with functional depots, foils are used with a thickness between 25 and 100 μm—preferred with a thickness of 35-80 μm and especially preferred with a thickness of 45-55 μm. If the foils are produced with reinforcing, at least partially in axially direction orientated profiles, these foils will feature a material thickness of 45-150 μm—preferred with a thickness of 80-100 μm—in the area of such profiles. Naturally, the thickness of the foil needs to be adapted to the size of the package according to the invention to be made, as well as to the intended maximum laundry capacity.

Corresponding to the intended volume of the first compartment a commercially available tube-shaped water-soluble foil will be cut to the required length and processed to the package with a first and at least a second compartment. For this, there are several modes of proceeding, well-known to a person skilled in the art. For example, it is possible to hot-seal the film-tube alongside the cutting edge, when it is cut to length to fill the intended washing agent, which should preferably be available as a powder, a granulate or in the form of compacted spherical bodies, into the resulting bag-shaped compartment, which is hot-sealed a second time after inserting the washing agent, in a way that at least a second compartment is formed, spatially separated from the first compartment, to keep the washing agent and when indicated other additives securely separated from the laundry in the first compartment, in order to prevent any undesired mixing prior to the washing process. Filling the second compartment with washing agent may lead to adhesion of dust from residues of the washing agent along the desired hot-sealing position. Therefore ultrasonic hot-sealing of the tube is advantageous, especially, when washing agents are inserted, which incline to dust. However, a thermal sealing process by means of compressing the tubular foil between two heated profiles in an appropriate way is also possible. Both sealing processes for foils are well known to a person skilled in the art. Generally, it is also possible to use a water-soluble bonding agent to stick the tubular foil at the desired positions. It is quintessential for realizing the invention that the water-soluble package with a separate functional depot is formed with a first compartment, intended to hold the laundry, needs to remain open initially—differently, it could not serve its purpose—in order to allow filling it with laundry, whilst the second and if needed other compartments, however, needs to be securely sealed after filling with washing agent—which may be a mild detergent, an agent for colored laundry, an all-purpose detergent, or others like a washing agent for curtains, or bleaching agent, disinfectant or any other substance required for the washing procedure, so that their content at the desired time is released in course of the washing process completely.

Basically, it is not necessary to produce the package according to the invention by means of cutting sections of an endless tube-shaped foil. In fact, it is also possible to fold a plain sheet of a suitable water-soluble foil and form a tube-like bag by hot-sealing or sticking two of its edges. Quintessential for realizing the invention is only the secure separation of the first and the second compartment, as well as any additional compartments, as needed. In another embodiment, the second and if needed any other compartments may also be positioned at the side or parallel to the first compartment need not to be, spatially separated, below the first compartment. This geometric structure can also be achieved by durably closing a section of a tube-shaped foil at the lower end by hot-sealing, and by applying a second seal vertically to the first one and, after filling this second compartment with the intended material, it will be closed with another seal. In a further embodiment, when producing a bag as described before, orient it in a way that one of its corners points downward, fill the washing agent into this corner and apply a hot-seal to close this section of the bag above the filling level. This procedure also provides a package with a functional depot according to the invention, in which the first and the second, and if needed, any other compartment, are spatially separated. However, the preferred and easiest method seems to be the production of the water-soluble package according to the invention from an endless tube-shaped foil with respective hot-seals running crosswise to the transport direction of the tube. In principle, it is also possible to produce the functional depot separately as a shaped part, for example by producing it as a section of a smaller tube-shaped foil and closed on only one side, filling this bag later on with the intended material, closing it, and fixing it durably at a suitable area of a larger section of a tubular foil. However, this is more complex than the production of the package according to the invention from only one tubular foil, the embodiments as describes first are more cost-efficient, and therefore are preferred.

Prior to its use, the water-soluble package according to the invention with functional depot needs to be folded as compact as possible, to allow easy packing and cost-efficient transportation to the sales outlets. Therefore, the embodiment, having the second compartment at the opposite end to the first compartment is to be preferred. Although other embodiments shall not be excluded basically.

If the water-soluble package according to the invention with functional depot is to be used to collect laundry for subsequent hot-wash, a further embodiment is provided, which features two portions of washing agent within the second compartment. The first portion is filled directly into the second compartment and is used for pre-washing with cold water. The second portion of the washing agent is inserted inside a separate bag, made of a type of foil, which only dissolves at temperatures above 50° C., in order to activate this portion of the washing agent only in the main washing cycle at elevated temperature. Respective foils providing the required characteristics are generally known to the men skilled in the art. The second portion of the washing agent is also inserted in the second compartment after which it is sealed in a way described above. The separate bag in that the washing agent was inserted—at this, any further substance to be used for the intended washing sequence, which means any additive such as phosphate-free water softener, bleaching agent, stain removers, disinfectant etc. is hereafter described simply as “washing agent”, since it is stored separately from the first compartment.

If the water-soluble package according to the invention with functional depot is to be used in an average household or for “normally soiled laundry”, it would be very desirable that the laundry gets into immediate contact with the washing liquid, as soon as the washing procedure starts. This can be achieved by means of a tubular foil, which features at least one area of reduced material thickness, as this section will soak through quickly and therefore rip after getting into contact with the washing liquid, thereby acting in a certain way “as a rated break point”. But this bears the danger of unintentional ripping along the “rated break point” of the provided package under mechanical load, while filling the package with laundry or during transport. For this reason, it is an advantage to at least partially perforate the walls of the first compartment by applying slots, holes or stamped-out design elements, such as the logotype of the respective manufacturer. The punching-waste may be re-used for producing future foils or tube-like foils. In order to increase the mechanical stability of the provided package, the edges of the open side of the first compartment should be folded at least once and durably bonded to the residual foil of the package, on order to double the thickness of the material in this area. The foils used for the package according to the invention should be shaped in a way, to soften after getting in contact with the washing liquid at the latest within 5 minutes—preferably within at the latest 3 minutes—in order to release the laundry contained in the package. Within at the latest 30 minutes—preferably within at the latest 20 minutes—the residual foil needs to be fully dissolved. It must also be excluded that residues of the foil stick to the laundry. However, this should not represent any insurmountable difficulty to a person skilled in the art, since this type of foils is basically nothing new. New is the utilization of these foils according to the invention for the manufacture of water-soluble packages with integrated functional depot.

In order to allow easy separation of different types of laundry and to improve working procedures in home and commercial applications, the package according to the invention with functional depot can be inserted into suitable stands, keeping the package open, in order to facilitate filling the first compartment with laundry. In order to prevent any confusion, it is advantageous to print the intended use onto the package, such as “wool”, “delicates”, “linen”, “colored laundry” or “hot wash” or indicating the respective washing temperature, such as “30° C.”, “40° C.”, “60° C.” or “90° C.” by imprinting or marking. It is quintessential for the invention that the amount of washing agents or other additives matches the maximum capacity of the first compartment. As substantial information both for the private and the commercial domain, there needs to be also a statement indicating the maximum capacity of the package, such as 1-2 kg, 3 kg, 5 kg, 6 kg, 7.5 kg, 10 kg 15 kg or 20 kg. In addition, it is possible to print information about the manufacturer, such as brand or company logotypes in their respective colors onto the package. Such markings can also be applied by the user himself by using suitable implements, such as markers with water-soluble ink, which naturally must not affect the laundry during the washing process. Manufacturers of writing utensils know such inks, based on water-soluble colorants, which are decolorized by means of so-called “ink killers”, as the colorant used is transferred into the so-called “leukoform”, by means of the accordant reagent. Since most washing agents also contain bleaching agents, the use of such pens should not represent any problem for the intended work procedure.

If the water-soluble package according to the invention is used for clinical applications to collect infectiously contaminated laundry, another embodiment should be selected, in which the second compartment will contain a disinfectant, preferably in solid form, and in addition to a washing agent, packed in a package, made from a foil, dissolving only at an elevated temperature, such as 50° C. or above, which means that the additional compartment is spatially separated from the first compartment. Possible is also another embodiment with a “three-fold effect”. In this case, the disinfectant is filled directly into the second compartment, a first portion of the washing agent is contained in a separate bag made of a foil dissolving in cold water, which will release the washing agent after a delay of some minutes for the pre-wash, whilst the second portion of the washing agent, contained in a second bag, is only released at elevated temperatures, such as 50° C. or above for the main washing cycle. The package with integrated functional depot according to the invention made of water-soluble foils, provided for infectiously contaminated laundry of a hospital, is to be used within a special safety area, by especially trained personnel, closing each unit by means of a suitable clip or a cord made of polyamide or polyester, hermetically sealed and later on brought into the washing machine, without being opened by the staff, when loading it. This represents a vital safety aspect. In this application as well, the water-soluble package according to the invention will dissolve completely during the washing process—only the sealing-aid remains intact and can be reconditioned and reused after emptying the washing machine. Particularly favorable in this connection will be to provide the package according to the invention solution in combination with at least one pair of rugged one-way gloves, in a combipack as they are available for clinical applications or to distribute it in units containing at least two or even multiple of such product combinations in a collective package. The number of such product combinations contained in one collective package is determined by the conditions of the market to match the requirements of the customer group, which are to be targeted with this product idea.

Work clothes used in smelly areas, as they are common in agriculture, poultry breeding, chemical industries, e.g. when handling mercaptanes or synthetic or other odorous substances, pharmaceutical industries and the like, can be a real bother if they are stored temporarily in a package according to this invention until the package is filled maximally. In a particular embodiment for these applications it is advantageous, to double the upper edges of the package, to bond the border area at least partially to the residual foil durably, in order to form a hollow space, and to pull through a stronger tape, made of water-soluble foil, which will allow closing the package according to the invention temporarily and allowing repeated opening and closing, until it is optimally filled and ready for washing, to avoid strong odor trouble or at least noticeably reduce it.

Alternatively, it is possible to replace the tape made of water-soluble foil by a tape made of textiles or a conventional cord made of polyamide, polyester or any other suitable material, or to use a clip to close the compartment temporarily, and to remove such closing from the washing machine after the washing process, in order to be re-used.

### BRIEF DESCRIPTION OF THE DRAWINGS

Further objects, features and advantages of the invention will be apparent from the following description of preferred embodiments thereof. These drawings are only exemplary and serve the purpose to demonstrate the object of the invention, without limiting it to a specific form or representing any final product characteristic. In particular, these drawings are not meant to determine any dimensions of the package. Individual components of the drawings are marked by reference numerals, which are further explained, in a subsequent descriptive text. In these drawings:

FIGS. 1(a)-(f) show a method for making a package according to the invention;

FIGS. 2(a)-(d) show alternate methods for making the package according to the invention;

FIG. 3 shows an application of the package in accordance with the invention;

FIGS. 4(a)-(d) show an alternate method for making a package according to the invention;

FIGS. 5(a)-(d) show a further alternate method for making a package according to the invention;

FIGS. 6(a)-(d) show a still further alternate method for making a package according to the invention;

FIGS. 7(a)-(d) show another alternate method for making a package according to the invention; and

FIGS. 8(a)-(f) illustrate alternative features and methods for making same, in accordance with the invention.

### DETAILED DESCRIPTION

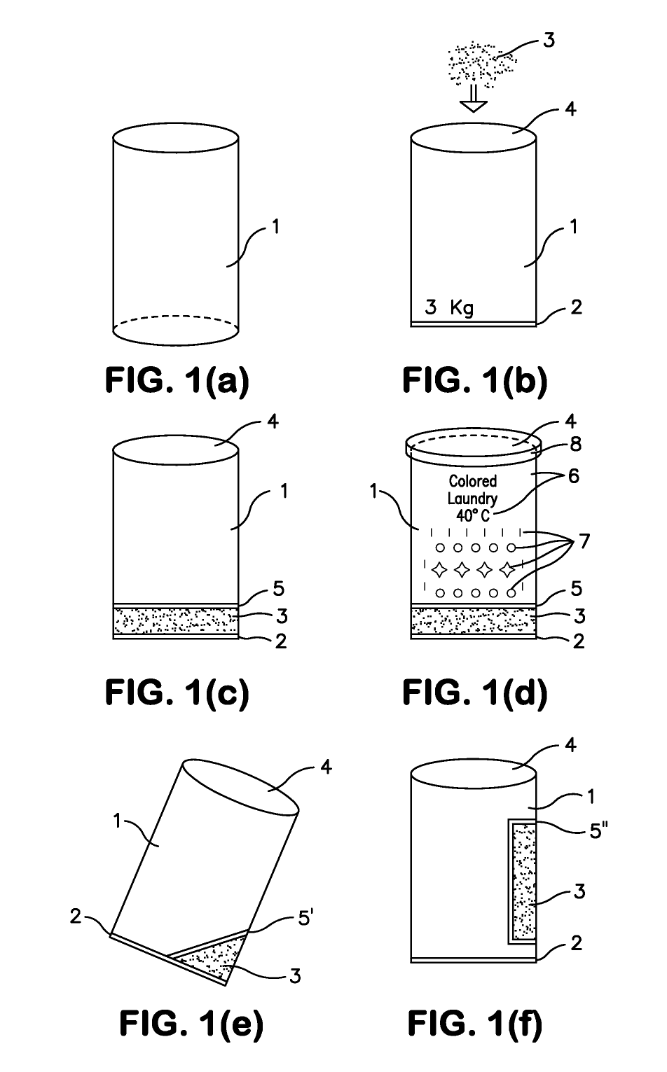

FIG. 1a shows a cut-off section 1 of the tubular foil made of water-soluble thermoplastic material, which in the first instance is open at both ends. FIG. 1b shows the same tubular foil with one end closed by means of hot-sealing or bonding 2, and is filled with washing agent or additives, as needed 3 through the opening 4. FIG. 1c shows a first embodiment of the package with functional depot according to the invention, where a hot-seal 5 or any other suitable form of closing means is positioned above the level of the washing agent 3 and horizontally to the transport direction of the tubular foil. FIG. 1d shows the package with functional depot according to the invention in which, in a suitable way, e.g. with an imprint, indicating the type of laundry to be filled in and the respective washing temperature 6, and where the walls are at least are partially furnished with slots, holes or figural perforations 7. The hem alongside the opening 4 was doubled 8 up by folding the foil. Naturally, there are other options for reinforcing the hem, but these would mean increased efforts and therefore higher production costs. FIG. 1e shows another embodiment of the package with functional depot, where one edge is directed downward, filled with washing agent 3 and where a hot-seal 5′ or any other suitable closing means is fixed above the level of the washing agent. FIG. 1f shows another embodiment with a second compartment being attached on the inside or the outside of the first compartment, spatially separated from that second compartment. For this purpose a separate piece of foil can be initially attached partially, then the so formed “bag” is filled with the washing agent 3 and to be hot-sealed 5″ afterwards. In this embodiment it is also possible, filling the washing agent into a separate reservoir made of a section of a suitable water-soluble foil, which is then closed and attached by hot-sealing or any other suitable procedure. However, the embodiment of FIG. 1f and described above, results in increased efforts and requires a higher amount of materials, which suggests to preferably use the embodiments described in the beginning.

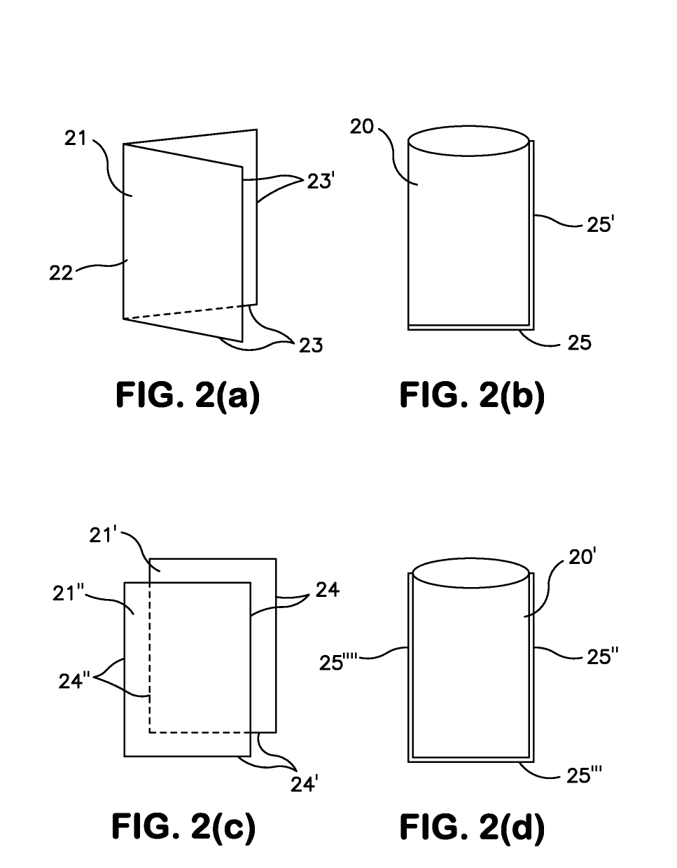

FIG. 2a shows a plain sheet made of a suitable water-soluble foil 21 which is folded in the middle 22 and hot-sealed on two sides in order to form the bag 20 as in FIG. 2b. Hot-sealing can either be carried out along two (more or less) vertical and horizontal adjacent, initially open sides 23, 23′, to meet then in a corner or along two parallel initially open sides. In either case, the result is a bag, which differs only as far as the position of the hot-sealed sides is concerned 25, 25′.

FIG. 2c finally shows two sheets of a foil 21′, 21″ which are positioned exactly above each other and are then interconnected along three sides 24, 24′, 24″ in order to form a type of bag 20′ as is shown in FIG. 2d, e.g. by hot-sealing, the bag then exhibiting three hot-seals 25″, 25′″, 25″″. The bags achieved in one of the ways described above form the basic element of a bag, which can be processed to the package with functional depot according to the invention. However, the procedural manners as aforesaid section require more work and material than the production of bags by cutting sections from a tubular foil—therefore the last-mentioned manufacturing procedure is to be preferred in practice.

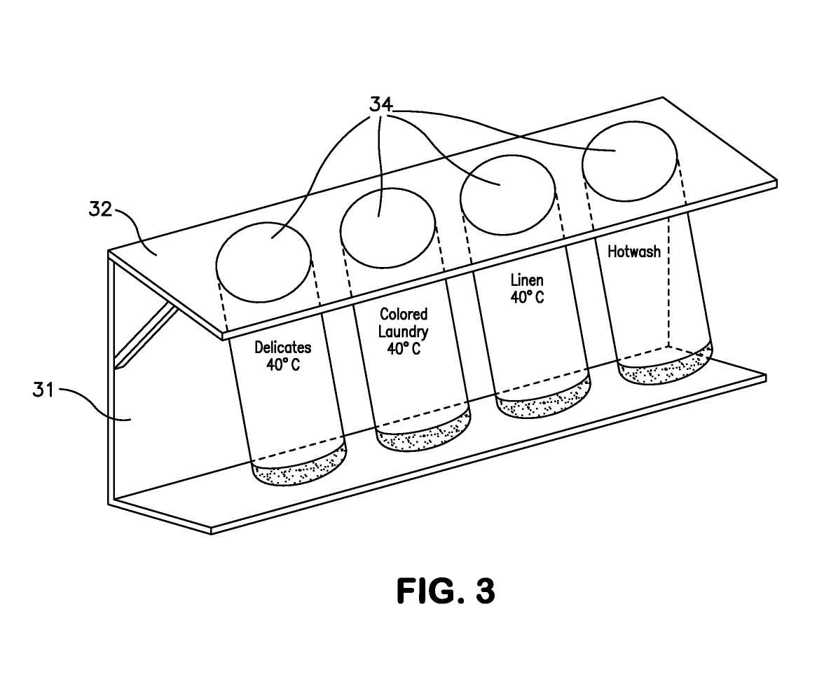

FIG. 3 shows one of the possible utilizations of a number of the water-soluble packages according to the invention with functional depot, to pre-sort laundry into categories, such as delicates, colored laundry, hot-wash and white laundry to be washed at 40° C., such as white shirts. For this, a foldable stand 31 with a top plate 32 with at least two openings 34, preferably four openings, such as shown in FIG. 3. can be used, each opening fitted with a package according to the invention, optimally opened for easy filling and easy removal. Also possible is a wall-mounted support to hold at least one of the water-soluble packages with functional depot according to the invention. The design principle of such stands or supports is basically known, since similar solutions are already on the market and widely used—quintessential again the combination of such a stand or support with the package with functional depot according to the invention for pre-sorting and subsequent processing of laundry.

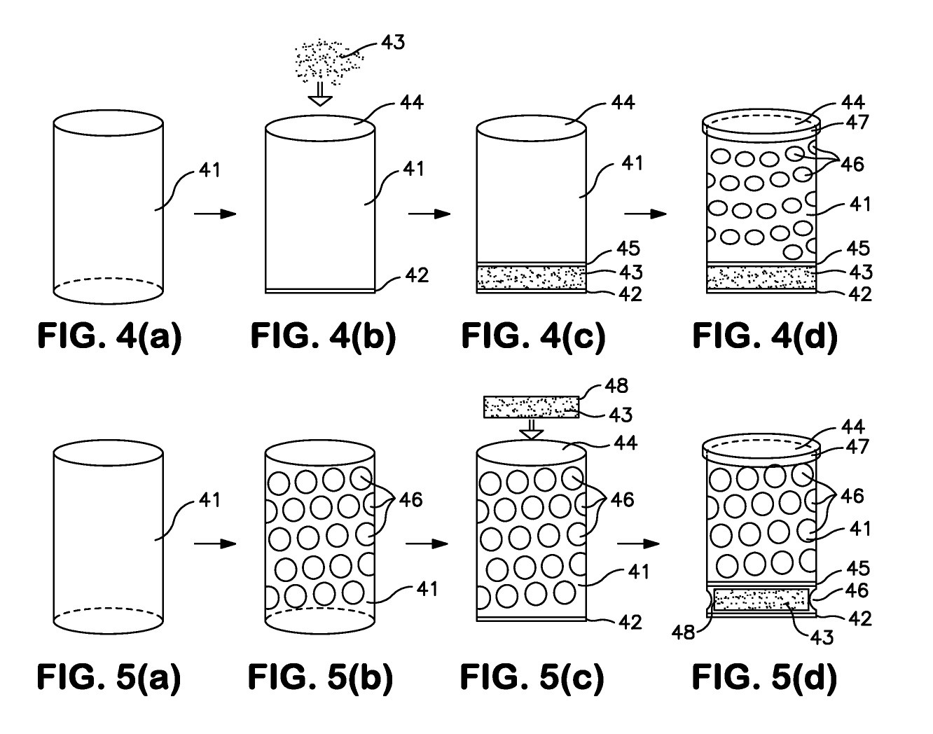

FIG. 4a shows a truncated section 41 of the tubular foil made of water-soluble plastic material, which initially remains open at both ends. FIG. 4b shows the same tubular foil with one end closed by appropriate means of hot-sealing or bonding 42, the resulting compartment filled through the opening 44 with washing agent or additional additives, if needed 43. FIG. 4c shows a first embodiment of the package according to the invention with functional depot, where a hot-seal 45 or any other suitable form of sealing is positioned above the level of the washing agent 43 and across the machine direction. FIG. 4d shows the package according to the invention with functional depot, where subsequently openings 46 were applied to the walls in a suitable manner, e.g. by punching, above the sealing 45. The hem alongside the opening 44 was doubled up by folding the foil in order to gain a hemstitch 47, in which e.g. a tape made of a likewise water-soluble material for closing the package can be drawn.

FIG. 5a shows a truncated section 41 of the tubular foil made of water-soluble plastic material, which initially remains open at both ends. FIG. 5b shows the very same tubular foil with punched-out openings 46. FIG. 5c shows the tubular foil closed on one side by hot-sealing or by bonding, in which the washing agent 43 or a required additive is contained in a bag 48 made of water-soluble foil. After inserting the bag 48, the lower partition of the package is closed by hot-sealing or bonding along the seam 45, as shown in FIG. 5d.

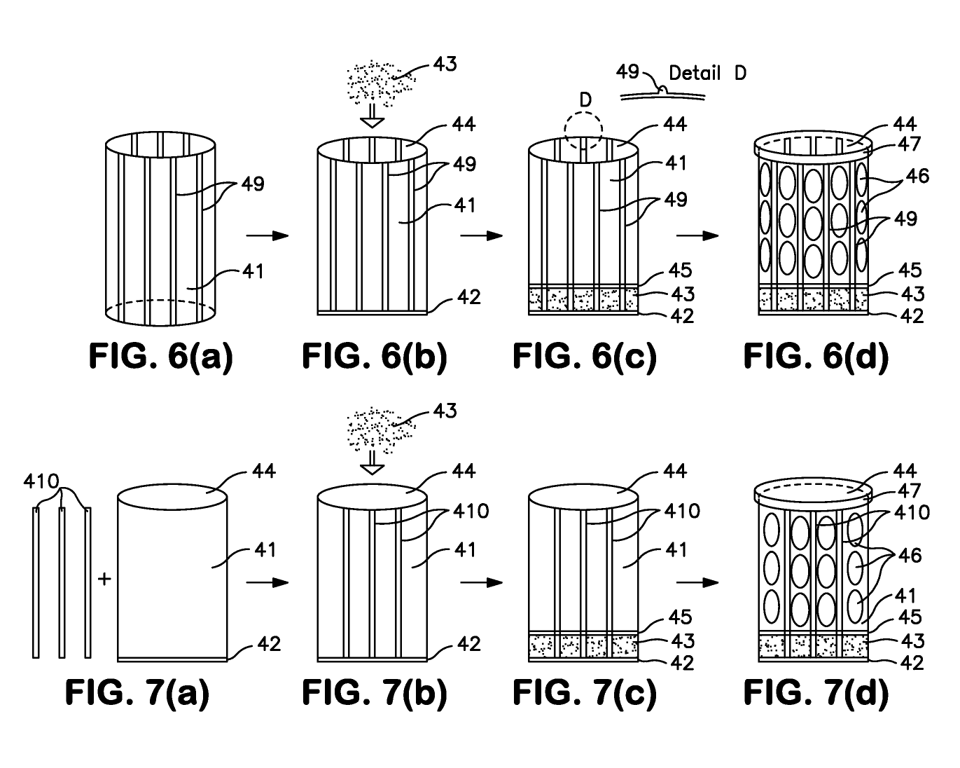

FIG. 6a shows a truncated section 41 of the tubular foil with “bearing and supporting elements” 49, made of a water-soluble plastic material, applied longitudinally in order to partially increase the thickness of the foil, initially still open at both ends. FIG. 6b shows the tubular foil, closed on one side along a seam 42 by hot-sealing or by bonding in a suitable manner, ready to be filled with the washing agent 43 or other additives, when required, through the opening 44. FIG. 6c shows the package closed by seam above the inserted amount of washing agent. Detail drawing D shows the “bearing and supporting elements” 49, used to increase the foil thickness. FIG. 6d shows the package according to the invention, ready for filling with laundry. The reference numbers result from FIG. 4 and FIG. 5.

FIG. 7a shows a truncated section 41 of the tubular foil, which is already closed at one end by a seam 42. Depending on the required carrying capacity of the package, a certain number of strips 410, made of water-soluble foil, are applied to the exterior of this foil section. Naturally, applying these strips can also been done before sealing the tube section at one end. If the tube section is turned inside out before closing it at one end, the strips of foil are at the interior of the package, avoiding ridges at the exterior. As shown in FIG. 7b, this tube section is now filled with the required washing agent 43 and other additives if needed, and hermetically sealed along the seam 45, as shown in FIG. 7c. FIG. 7d shows the invented package according to the invention with a number of openings 46 punched into the open part of the bag, which is intended to hold the laundry afterwards, whereas this preferably should be done in a way that the strips of foil 46 either remain intact or are only punched out partially, in order to prevent limiting the stabilizing function accomplished by applying those strips.

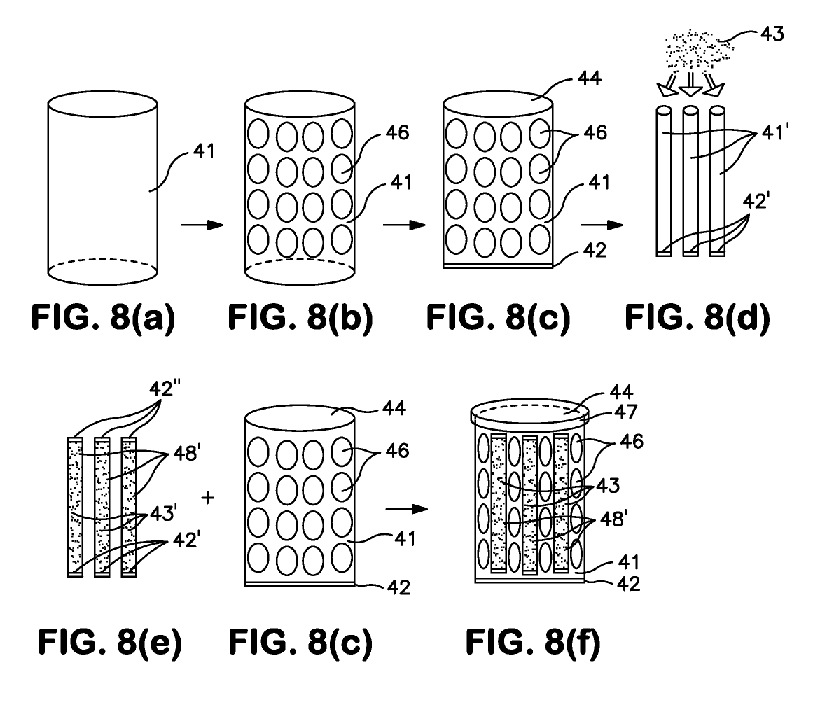

FIG. 8a shows a truncated section 41 of the tubular foil with a number of openings 46, as shown in FIG. 8b intended to reduce the overall weight of the package according to the invention. FIG. 8c shows the same punched tubular foil after being closed at one end by a seam 42. FIG. 8d shows truncated sections of a tubular foil with much smaller diameter 41′, which are closed at one end 42′ by a seam. Subsequently these truncated sections 41′ are filled with the required washing agent 43 and other additives, if needed, and followed by tightly sealing at the other end by means of a second seam 42″. After filling, these sections of tubular foil are providing the reservoir of washing agent 48′, whereas the length of this reservoir corresponds to the length of the truncated tubular foil, as shown in FIG. 8c, reaching from the seam at one end to the doubled up hem 47 at the other end, which will be applied in a later production stage.

At least two of these reservoirs with washing agent 48′ are applied to the truncated tubular foil shown in FIG. 8c, which is closed at one end. The dimension of the reservoir with washing agent 48′ and the number of reservoirs needed depend on the calculated amount of laundry the package according to the invention with functional depot is intended for afterwards.

What is claimed is:

1. A water-soluble package, comprising a water-soluble foil defining a first compartment and at least one second compartment separate from the first compartment, wherein the at least one second compartment contains a functional depot.

2. Package according to claim 1, wherein the first compartment is spatially separated from the at least one second compartment.

3. Package according to claim 1 wherein the first compartment can be used to hold laundry, and wherein the functional depot comprises washing agents.

4. Package according to claim 3, wherein the at least one second compartment is sealed in a way that washing agent in the at least one second compartment cannot enter into the first compartment.

5. Package according to claim 3, wherein the amount of washing agent which is contained in the at least one second compartment is coordinated to the capacity of laundry in the first compartment.

6. Package according to claim 5, wherein the washing agent is provided in the form of a powder, granulate or in compacted solid form.

7. Package according to claim 5, wherein the washing agent is a mild detergent suitable for washing delicates, wool or colored laundry.

8. Package according to claim 5, wherein the washing agent is a premium detergent suitable for washing linen or hot wash.

9. Package according to claim 3, wherein the functional depot further comprises additional additives.

10. Package according to claim 9, wherein the additional additives comprise a disinfectant.

11. Package according to claim 1, wherein the first compartment has a volume suitable to hold laundry with a total weight between 1 and 20 kg.

12. Package according to claim 11, wherein the package is coordinated for use in private households, with a capacity for 1-2 kg, 3 kg, 4-5 kg or 6 kg of laundry, and wherein the amount of washing agent is coordinated to the respective volume.

13. Package according to claim 11, wherein the package is coordinated for use in commercial applications with a capacity of 7.5 kg, 10 kg, 15 kg and 20 kg for laundry, and wherein the amount of washing agent is coordinated to the respective volume.

14. Package according to claim 1, wherein the package comprises an additional compartment defined by a sealed package, made of a foil, which will dissolve only at a water temperature of 50° C. or above, and wherein the additional compartment is inserted into the second compartment.

15. Package according to claim 14, wherein the sealed package is filled with a washing agent designed for use at a water temperature of 50° C. or above.

16. Package according to claim 1, wherein the water-soluble foil is selected from the group consisting of a mixture of polyvinyl acetate and polyacrylic acid, polyvinyl alcohol, partially hydrolyzed polyvinyl alcohol, a copolymer of N-vinyl acetamide and vinyl acetate, a copolymer of N-vinyl acetamide and vinyl butyrate, hydroxypropyl cellulose, a polycondensate from polyvinyl alcohol and dimethyl tartrate, a polycondensate of polyvinyl alcohol and citric acid and phthalic acid anhydride, a polycondensate of polyvinyl alcohol and maleic acid anhydride and citric acid, so-called biopolymers and combinations thereof.

17. Package according to claim 1, wherein the water-soluble foil will dissolve when contacted with water after a maximum delay of 5 minutes, to a degree to release the contents of the bag.

18. Package according to claim 1, wherein the water soluble foil produces residues which will totally dissolve in washing liquid at the latest within 30 minutes.

19. Package as set forth in claim 1, wherein the foil surrounding the first compartment is at least partially perforated.

20. Package as set forth in claim 19, wherein the perforation has the form of slots, holes or design elements formed by stamped-out holes.

21. Package as set forth in claim 1, wherein the package is repeatedly punched out with suitable punches, to produce a net-like structure.

22. Package of claim 21, wherein spaces in the net-like structure are sized smaller than the smallest piece of laundry for which the package is intended.

23. Package of claim 21, wherein the water-soluble foil is re-enforced by axially applied partial profiles.

24. Package of claim 23, wherein the openings are positioned to not interfere with the function of the reinforcing structures.

25. Package of claim 23, wherein the package has a tear-resistance which is at least 50% higher than the respective maximum total weight of a fully filled package.

26. Package of claim 21, wherein the second compartment comprises a number of sealed sections of tubular foil which contain washing agent and which are applied to the first compartment in order to serve as bearing and supporting elements.

27. Package of claim 26, wherein the geometry and number of the sealed sections of tubular foil is derived from the maximum capacity of the first compartment.

28. Package made of water-soluble plastic material which defines a first compartment to hold a predetermined amount of laundry and at least one second compartment to hold a functional depot in the form of an amount of washing agent, required for the intended washing procedure, wherein the plastic material is woven from an endless filament to form a net-like plain or tube-like fabric.

29. Package of claim 28, wherein the knot-like sections of the fabric are subjected to short thermal treatment in order to strengthen it stability and get it inherently stable.

30. A method for producing a bag, comprising:
obtaining a bag made from foil, the bag defining a first compartment;
filling the bag with a specified amount of washing agent; and
sealing the bag above the filling level of washing agent in order to form a second compartment containing the washing agent.

31. The method of claim 30, wherein the foil has a thickness between 25 and 100 μm.

32. The method of claim 30, wherein the foil has a thickness of 35 to 80 μm.

33. The method of claim 30, wherein the foil has a thickness of 45 to 55 μm.

34. The method of claim 30, wherein the foil has profiles in an axial direction to increase its tensile strength.

35. The method of claim 30, wherein the foil has a thickness between 45 and 150 μm in the area of the profiles.

36. The method of claim 34, wherein the foil has a thickness between 80 and 100 μm in the area of the profiles.

37. The method of claim 30, wherein the bag is made by closing one open end of a section of tube-shaped foil by hot-sealing to produce the bag.

38. The method of claim 30, wherein the bag is made from a plain pre-cut part of water-soluble foil by folding the foil and hot-sealing alongside two parallel edges.

39. The method of claim 30, wherein the bag is made from a plain pre-cut part of water-soluble foil by folding that foil and hot-sealing it alongside two edges which are joining each other at one corner point.

40. The method of claim 30, wherein the bag is made from two plain pre-cut parts of water-soluble foil which are positioned exactly on top of each other and hot-sealed alongside three edges.

41. The method of claim 30, further comprising the step of folding the open end of the bag at least once and fastened to the tubular foil to form a reinforcement hem.

42. The method of claim 41, wherein the folded hem forms a hollow space alongside the open end of the first compartment.

43. The method of claim 42, wherein the hollow space is provided with a reinforced tape of water-soluble foil, which allows temporary closing and re-opening of the package.

44. The method of claim 42, wherein the hollow space is provided with a textile tape, which allows temporary closing and re-opening of the package.

45. The method of claim 42, wherein the hollow space is equipped with a cord made of polyamide or polyester, which allows temporary closing and re-opening of the package.

46. The method of claim 30, wherein a number of strips made of water-soluble foil are applied to the foil, which is tailored to the required load capacity.

47. The method of claim 46, wherein the strips of foil are applied by means of ultrasonic sealing or by moistening them in order to cause a sticking effect.

48. The method of claim 30, wherein the punched-out holes save at least 50% of the previous weight of the plastic material of the package.

49. The method of claim 30, wherein the punched-out holes save at least 70% of the previous weight of the plastic material of the package.

50. The method of claim 30, wherein the punched-out holes save at least 80% of the previous weight of the plastic material of the package.

51. Utilization of a granulate comprising a mixture of polyvinyl acetate and polyacrylic acid, polyvinyl alcohol, or partially hydrolyzed polyvinyl alcohol, a copolymer of N-vinyl acetamide and vinyl acetate, a copolymer of N-vinyl acetamide and vinyl butyrate, hydroxypropyl cellulose, a polycondensate of polyvinyl alcohol and dimethyl tartrate, a polycondensate of polyvinyl alcohol and citric acid and phthalic acid anhydride or a polycondensate of polyvinyl alcohol and maleic acid anhydride and citric acid, so-called biopolymers or mixtures of these polymers, copolymers and polycondensates for the manufacture of a tube-shaped foil.

52. A method for storing infectiously contaminated laundry and transporting to a washing machine, comprising the steps of:
providing a package according to claim 1;
storing the infectiously contaminated laundry in the package;
sealing the package containing the infectiously contaminated laundry; and
transporting the sealed package to a washing machine, whereby the package can be placed in the washing machine without needing to open it.

53. The method of claim 52, wherein the package is provided in combination with at least one pair of solid one-way gloves.

54. The method of claim 53, wherein at least two of these product combinations are provided as a single kit.
